(19) United States
(12) Patent Application Publication
(10) Pub. No.: US 2003/0061296 A1
(43) Pub. Date: Mar. 27, 2003

(54) Memory semantic storage I/O

(75) Inventors: David F. Craddock, New Paltz, NY (US); Charles Scott Graham, Rochester, MN (US); Ian David Judd, Otterbourne (GB); Renato John Recio, Austin, TX (US); Timothy Jerry Schimke, Oronoco, MN (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/961,952

(22) Filed: Sep. 24, 2001

(51) Int. Cl. G06F 15/167

(52) U.S. Cl. 709/212

(57) ABSTRACT

A mechanism for initiating and completing one or more I/O transactions using memory semantic messages is disclosed. Memory semantic messages are transmitted by means of a remote direct memory access (RDMA) operation; they are more akin to a memory copy than the simple transmission of a message.

### BACKGROUND OF THE INVENTION

1. Technical Field

The present invention generally relates to communication protocols between a host computer and an input/output (I/O) device. More specifically, the present invention provides a method by which an I/O device can communicate over a network to a general purpose processing node (a.k.a. host, host computer) using memory semantic messages.

2. Description of Related Art

In a System Area Network (SAN), the hardware provides a message passing mechanism that can be used for Input/Output devices (I/O) and interprocess communications between general computing nodes (IPC). Processes executing on devices access SAN message passing hardware by posting send/receive messages to send/receive work queues on a SAN channel adapter (CA). These processes also are referred to as “consumers”.

The send/receive work queues (WQ) are assigned to a consumer as a queue pair (QP). The messages can be sent over five different transport types: Reliable Connected (RC), Reliable datagram (RD), Unreliable Connected (UC), Unreliable Datagram (UD), and Raw Datagram (RawD). Consumers retrieve the results of these messages from a completion queue (CQ) through SAN send and receive work completion (WC) queues. The source channel adapter takes care of segmenting outbound messages and sending them to the destination. The destination channel adapter takes care of reassembling inbound messages and placing them in the memory space designated by the destination's consumer.

Two channel adapter types are present in nodes of the SAN fabric, a host channel adapter (HCA) and a target channel adapter (TCA). The host channel adapter is used by general purpose computing nodes to access the SAN fabric. Consumers use SAN verbs to access host channel adapter functions. The software that interprets verbs and directly accesses the channel adapter is known as the channel interface (CI).

Target channel adapters (TCA) are used by nodes that are the subject of messages sent from host channel adapters. The target channel adapters serve a similar function as that of the host channel adapters in providing the target node an access point to the SAN fabric.

To make efficient use of storage devices within a SAN, however, a consumer protocol is needed to attach advanced function storage subsystems to general-purpose computers.

### SUMMARY OF THE INVENTION

The present invention provides a method, computer program product, and distributed data processing system for processing storage I/O in a system area network (SAN). The distributed data processing system comprises end nodes, switches, routers, and links interconnecting the components. The end nodes use send and receive pairs to transmit and receive messages. The end nodes segment the message into packets and transmit the packets over the links. The switches and routers interconnect the end nodes and route the packets to the appropriate end nodes. The end nodes reassemble the packets into a message at the destination. An I/O transaction represents a unit of I/O work and typically contains multiple messages. An example I/O transaction is a read from a specific disk sector into a specific host memory location. I/O transactions are typically initiated by a host consumer, but can also be initiated by an I/O device. The present invention provides a mechanism for initiating and completing one or more I/O transactions using memory semantic messages. Memory semantic messages are transmitted by means of a remote direct memory access (RDMA) operation; they are more akin to a memory copy than the simple transmission of a message.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed computer system is illustrated in accordance with a preferred embodiment of the present invention;

FIG. 2 is a functional block diagram of a host processor node in accordance with a preferred embodiment of the present invention;

FIG. 3A is a diagram of a host channel adapter in accordance with a preferred embodiment of the present invention;

FIG. 3B is a diagram of a switch in accordance with a preferred embodiment of the present invention;

FIG. 3C is a diagram of a router in accordance with a preferred embodiment of the present invention;

FIG. 4 is a diagram illustrating processing of work requests in accordance with a preferred embodiment of the present invention;

FIG. 5 is a diagram illustrating a portion of a distributed computer system in accordance with a preferred embodiment of the present invention in which a reliable connection service is used;

FIG. 6 is a diagram illustrating a portion of a distributed computer system in accordance with a preferred embodiment of the present invention in which reliable datagram service connections are used;

FIG. 7 is an illustration of a data packet in accordance with a preferred embodiment of the present invention;

FIG. 8 is a diagram illustrating a portion of a distributed computer system in accordance with a preferred embodiment of the present invention;

FIG. 9 is a diagram illustrating the network addressing used in a distributed networking system in accordance with the present invention;

FIG. 10 is a diagram illustrating a portion of a distributed computing system in accordance with a preferred embodiment of the present invention in which the structure of SAN fabric subnets is illustrated;

FIG. 11 is a diagram of a layered communication architecture used in a preferred embodiment of the present invention;

FIG. 12 is a diagram showing the flow of Communication Management packets to establish a connection and exchange private data in a preferred embodiment of the present invention;

FIG. 13 is a diagram of the operation of an upper-level memory semantic write protocol in accordance with a preferred embodiment of the present invention;

FIG. 14 is a diagram of the operation of an upper-level memory semantic read protocol in accordance with a preferred embodiment of the present invention;

FIG. 15A is a flowchart representation of the operation of an upper-level memory semantic input/output write protocol in accordance with a preferred embodiment of the present invention; and

FIG. 15B is a flowchart representation of the operation of an upper-level memory semantic input/output read protocol in accordance with a preferred embodiment of the present invention.

### DETAILED DESCRIPTION OF THE PREFERRED EMBODIMENT

The present invention provides a distributed computing system having end nodes, switches, routers, and links interconnecting these components. Each end node uses send and receive queue pairs to transmit and receive messages. The end nodes segment the message into packets and transmit the packets over the links. The switches and routers interconnect the end nodes and route the packets to the appropriate end node. The end nodes reassemble the packets into a message at the destination.

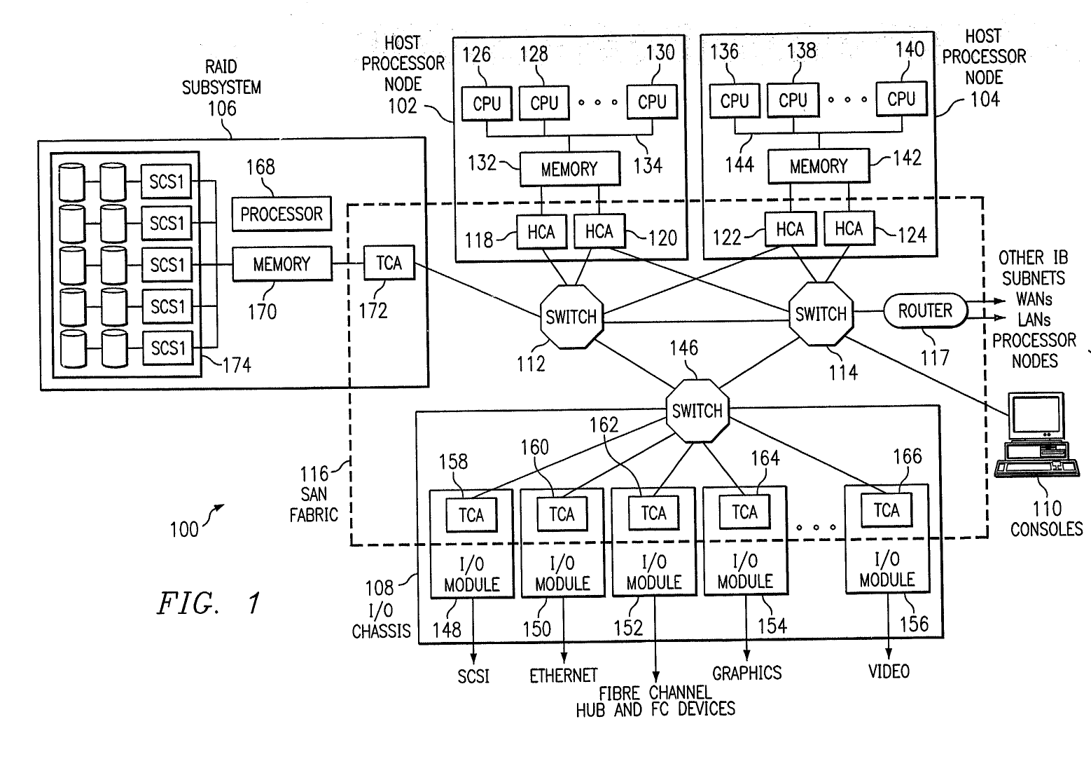

With reference now to the figures and in particular with reference to FIG. 1, a diagram of a distributed computer system is illustrated in accordance with a preferred embodiment of the present invention. The distributed computer system represented in FIG. 1 takes the form of a system area network (SAN) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an internet or intranet.

SAN 100 is a high-bandwidth, low-latency network interconnecting nodes within the distributed computer system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, and I/O chassis node 108. The nodes illustrated in FIG. 1 are for illustrative purposes only, as SAN 100 can connect any number and any type of independent processor nodes, I/O adapter nodes, and I/O device nodes. Any one of the nodes can function as an endnode, which is herein defined to be a device that originates or finally consumes messages or packets in SAN 100.

In one embodiment of the present invention, an error handling mechanism in distributed computer systems is present in which the error handling mechanism allows for reliable connection or reliable datagram communication between end nodes in a distributed computing system, such as SAN 100.

A message, as used herein, is an application-defined unit of data exchange, which is a primitive unit of communication between cooperating processes. A packet is one unit of data encapsulated by networking protocol headers and/or trailers. The headers generally provide control and routing information for directing the packet through SAN 100. The trailer generally contains control and cyclic redundancy check (CRC) data for ensuring packets are not delivered with corrupted contents.

SAN 100 contains the communications and management infrastructure supporting both I/O and interprocessor communications (IPC) within a distributed computer system. The SAN 100 shown in FIG. 1 includes a switched communications fabric 116, which allows many devices to concurrently transfer data with high-bandwidth and low latency in a secure, remotely managed environment. Endnodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing frames from one link in a first subnet to another link in a second subnet using a large header Destination Globally Unique Identifier (DGUID).

In one embodiment, a link is a full duplex channel between any two network fabric elements, such as endnodes, switches, or routers. Example suitable links include, but are not limited to, copper cables, optical cables, and printed circuit copper traces on backplanes and printed circuit boards.

For reliable service types, endnodes, such as host processor endnodes and I/O adapter endnodes, generate request packets and return acknowledgment packets. Switches and routers pass packets along, from the source to the destination. Except for the variant CRC trailer field, which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, and I/O chassis 108 include at least one channel adapter (CA) to interface to SAN 100. In one embodiment, each channel adapter is an endpoint that implements the channel adapter interface in sufficient detail to source or sink packets transmitted on SAN fabric 100. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapters 118 and 120 provide a connection to switch 112 while host channel adapters 122 and 124 provide a connection to switches 112 and 114.

In one embodiment, a host channel adapter is implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communications (IPC) consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers.

The I/O chassis 108 in FIG. 1 includes an I/O switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel-arbitrated loop (FC-AL) devices for I/O module 152; an ethernet adapter card for I/O module 150; a graphics adapter card for I/O module 154; and a video adapter card for I/O module 156. Any known type of adapter card can be implemented. I/O adapters also include a switch in the I/O adapter backplane to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among themselves or communicate with any or all of the processor nodes in a distributed computer system. With an I/O adapter attached to the SAN 100, the resulting I/O adapter node has substantially the same communication capability as any host processor node in SAN 100.

In one embodiment, the SAN 100 shown in FIG. 1 supports channel semantics and memory semantics. Channel semantics is sometimes referred to as send/receive or push communication operations. Channel semantics are the type of communications employed in a traditional I/O channel where a source device pushes data and a destination device determines a final destination of the data. In channel semantics, the packet transmitted from a source process specifies a destination processes' communication port, but does not specify where in the destination processes' memory space the packet will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved in the transfer of any data. Thus, in memory semantics, a source process sends a data packet containing the destination buffer memory address of the destination process. In memory semantics, the destination process previously grants permission for the source process to access its memory.

Channel semantics and memory semantics are typically both necessary for I/O and interprocessor communications. A typical I/O operation employs a combination of channel and memory semantics. In an illustrative example I/O operation of the distributed computer system shown in FIG. 1, a host processor node, such as host processor node 102, initiates an I/O operation by using channel semantics to send a disk write command to a disk I/O adapter, such as RAID subsystem target channel adapter (TCA) 172. The disk I/O adapter examines the command and uses memory semantics to read the data buffer directly from the memory space of the host processor node. After the data buffer is read, the disk I/O adapter employs channel semantics to push an I/O completion message back to the host processor node.

In one exemplary embodiment, the distributed computer system shown in FIG. 1 performs operations that employ virtual addresses and virtual memory protection mechanisms to ensure correct and proper access to all memory. Applications running in such a distributed computer system are not required to use physical addressing for any operations.

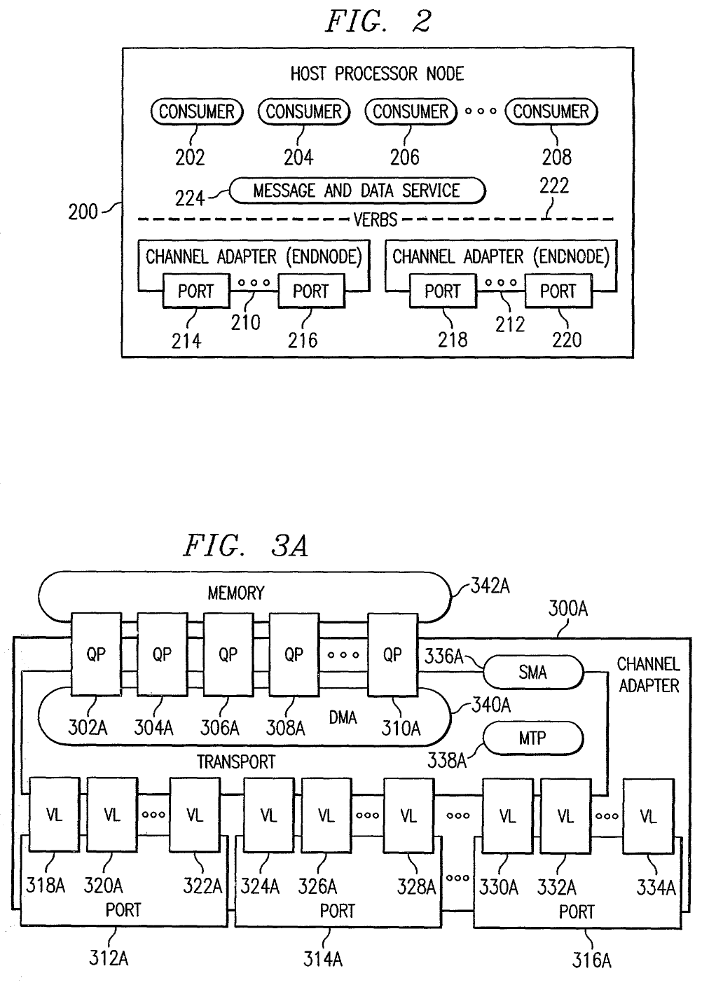

Turning next to FIG. 2, a functional block diagram of a host processor node is depicted in accordance with a preferred embodiment of the present invention. Host processor node 200 is an example of a host processor node, such as host processor node 102 in FIG. 1. In this example, host processor node 200 shown in FIG. 2 includes a set of consumers 202-208, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality through its programming interface. Basically, this interface defines the behavior of the host. Additionally, host processor node 200 includes a message and data service 224, which is a higher-level interface than the verb layer and is used to process messages and data received through channel adapter 210 and channel adapter 212. Message and data service 224 provides an interface to consumers 202-208 to process messages and other data.

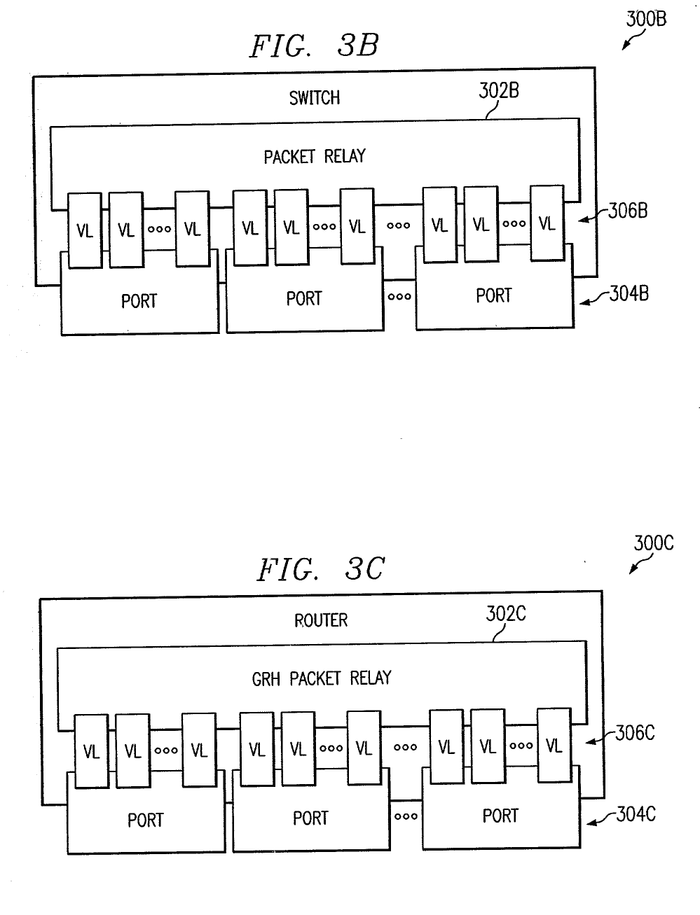

With reference now to FIG. 3A, a diagram of a host channel adapter is depicted in accordance with a preferred embodiment of the present invention. Host channel adapter 300A shown in FIG. 3A includes a set of queue pairs (QPs) 302A-310A, which are used to transfer messages to the host channel adapter ports 312A-316A. Buffering of data to host channel adapter ports 312A-316A is channeled through virtual lanes (VL) 318A-334A where each VL has its own flow control. Subnet manager configures channel adapters with the local addresses for each physical port, i.e., the port's LID. Subnet manager agent (SMA) 336A is the entity that communicates with the subnet manager for the purpose of configuring the channel adapter. Memory translation and protection (MTP) 338A is a mechanism that translates virtual addresses to physical addresses and validates access rights. Direct memory access (DMA) 340A provides for direct memory access operations using memory 342A with respect to queue pairs 302A-310A.

A single channel adapter, such as the host channel adapter 300A shown in FIG. 3A, can support thousands of queue pairs. By contrast, a target channel adapter in an I/O adapter typically supports a much smaller number of queue pairs. Each queue pair consists of a send work queue (SWQ) and a receive work queue. The send work queue is used to send channel and memory semantic messages. The receive work queue receives channel semantic messages. A consumer calls an operating-system specific programming interface, which is herein referred to as verbs, to place work requests (WRs) onto a work queue.

FIG. 3B depicts a switch 300B in accordance with a preferred embodiment of the present invention. Switch 300B includes a packet relay 302B in communication with a number of ports 304B through virtual lanes such as virtual lane 306B. Generally, a switch such as switch 300B can route packets from one port to any other port on the same switch.

Similarly, FIG. 3C depicts a router 300C according to a preferred embodiment of the present invention. Router 300C includes a packet relay 302C in communication with a number of ports 304C through virtual lanes such as virtual lane 306C. Like switch 300B, router 300C will generally be able to route packets from one port to any other port on the same router.

Channel adapters, switches, and routers employ multiple virtual lanes within a single physical link. As illustrated in FIGS. 3A, 3B, and 3C, physical ports connect endnodes, switches, and routers to a subnet. Packets injected into the SAN fabric follow one or more virtual lanes from the packet's source to the packet's destination. The virtual lane that is selected is mapped from a service level associated with the packet. At any one time, only one virtual lane makes progress on a given physical link. Virtual lanes provide a technique for applying link level flow control to one virtual lane without affecting the other virtual lanes. When a packet on one virtual lane blocks due to contention, quality of service (QoS), or other considerations, a packet on a different virtual lane is allowed to make progress.

Virtual lanes are employed for numerous reasons, some of which are as follows: Virtual lanes provide QoS. In one example embodiment, certain virtual lanes are reserved for high priority or isochronous traffic to provide QoS.

Virtual lanes provide deadlock avoidance. Virtual lanes allow topologies that contain loops to send packets across all physical links and still be assured the loops won't cause back pressure dependencies that might result in deadlock.

Virtual lanes alleviate head-of-line blocking. When a switch has no more credits available for packets that utilize a given virtual lane, packets utilizing a different virtual lane that has sufficient credits are allowed to make forward progress.

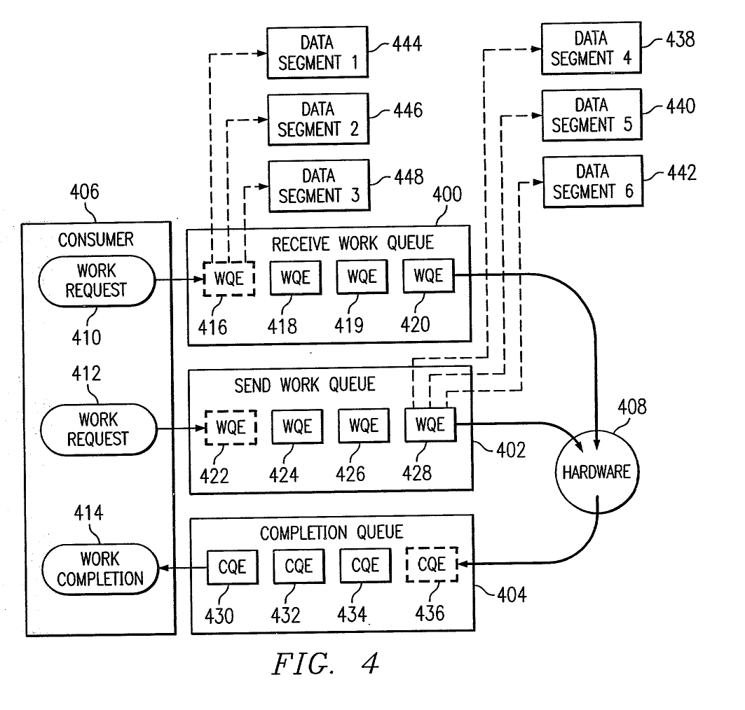

With reference now to FIG. 4, a diagram illustrating processing of work requests is depicted in accordance with a preferred embodiment of the present invention. In FIG. 4, a receive work queue 400, send work queue 402, and completion queue 404 are present for processing requests from and for consumer 406. These requests from consumer 406 are eventually sent to hardware 408. In this example, consumer 406 generates work requests 410 and 412 and receives work completion 414. As shown in FIG. 4, work requests placed onto a work queue are referred to as work queue elements (WQEs).

Send work queue 402 contains work queue elements (WQEs) 422-428, describing data to be transmitted on the SAN fabric. Receive work queue 400 contains work queue elements (WQEs) 416-420, describing where to place incoming channel semantic data from the SAN fabric. A work queue element is processed by hardware 408 in the host channel adapter.

The verbs also provide a mechanism for retrieving completed work from completion queue 404. As shown in FIG. 4, completion queue 404 contains completion queue elements (CQEs) 430-436. Completion queue elements contain information about previously completed work queue elements. Completion queue 404 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 402 shown in FIG. 4 are as follows. A send work request is a channel semantic operation to push a set of local data segments to the data segments referenced by a remote node's receive work queue element. For example, work queue element 428 contains references to data segment 4 438, data segment 5 440, and data segment 6 442. Each of the send work request's data segments contains part of a virtually contiguous memory region. The virtual addresses used to reference the local data segments are in the address context of the process that created the local queue pair.

A remote direct memory access (RDMA) read work request provides a memory semantic operation to read a virtually contiguous memory space on a remote node. A memory space can either be a portion of a memory region or portion of a memory window. A memory region references a previously registered set of virtually contiguous memory addresses defined by a virtual address and length. A memory window references a set of virtually contiguous memory addresses that have been bound to a previously registered region.

The RDMA Read work request reads a virtually contiguous memory space on a remote endnode and writes the data to a virtually contiguous local memory space. Similar to the send work request, virtual addresses used by the RDMA Read work queue element to reference the local data segments are in the address context of the process that created the local queue pair. The remote virtual addresses are in the address context of the process owning the remote queue pair targeted by the RDMA Read work queue element.

A RDMA Write work queue element provides a memory semantic operation to write a virtually contiguous memory space on a remote node. The RDMA Write work queue element contains a scatter list of local virtually contiguous memory spaces and the virtual address of the remote memory space into which the local memory spaces are written.

A RDMA Atomic work queue element provides a memory semantic operation to perform an atomic operation on a remote word. The RDMA Atomic work queue element is a combined RDMA Read, Modify, and RDMA Write operation. The RDMA Atomic work queue element can support several read-modify-write operations, such as Compare and Swap if equal.

A bind (unbind) remote access key (R_Key) work queue element provides a command to the host channel adapter hardware to modify (destroy) a memory window by associating (disassociating) the memory window to a memory region. The R_Key is part of each RDMA access and is used to validate that the remote process has permitted access to the buffer.

In one embodiment, receive work queue 400 shown in FIG. 4 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. For example, work queue element 416 in receive work queue 400 references data segment 1 444, data segment 2 446, and data segment 3 448. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero processor-copy data transfer provides for efficient support of high-bandwidth and low-latency communication.

When a queue pair is created, the queue pair is set to provide a selected type of transport service. In one embodiment, a distributed computer system implementing the present invention supports four types of transport services: reliable connection, unreliable connection, reliable datagram, and unreliable datagram service.

Reliable and Unreliable connected services associate a local queue pair with one and only one remote queue pair. Connected services require a process to create a queue pair for each process that is to communicate with over the SAN fabric. Thus, if each of N host processor nodes contain P processes, and all P processes on each node wish to communicate with all the processes on all the other nodes, each host processor node requires P²×(N−1) queue pairs. Moreover, a process can connect a queue pair to another queue pair on the same host channel adapter.

A portion of a distributed computer system employing a reliable connection service to communicate between distributed processes is illustrated generally in FIG. 5. The distributed computer system 500 in FIG. 5 includes a host processor node 1, a host processor node 2, and a host processor node 3. Host processor node 1 includes a process A 510. Host processor node 2 includes a process C 520 and a process D 530. Host processor node 3 includes a process E 540.

Host processor node 1 includes queue pairs 4, 6 and 7, each having a send work queue and receive work queue. Host processor node 3 has a queue pair 9 and host processor node 2 has queue pairs 2 and 5. The reliable connection service of distributed computer system 500 associates a local queue pair with one and only one remote queue pair. Thus, the queue pair 4 is used to communicate with queue pair 2; queue pair 7 is used to communicate with queue pair 5; and queue pair 6 is used to communicate with queue pair 9.

A WQE placed on one send queue in a reliable connection service causes data to be written into the receive memory space referenced by a Receive WQE of the connected queue pair. RDMA operations operate on the address space of the connected queue pair.

In one embodiment of the present invention, the reliable connection service is made reliable because hardware maintains sequence numbers and acknowledges all packet transfers. A combination of hardware and SAN driver software retries any failed communications. The process client of the queue pair obtains reliable communications even in the presence of bit errors, receive underruns, and network congestion. If alternative paths exist in the SAN fabric, reliable communications can be maintained even in the presence of failures of fabric switches, links, or channel adapter ports.

In addition, acknowledgments may be employed to deliver data reliably across the SAN fabric. The acknowledgment may, or may not, be a process level acknowledgment, i.e. an acknowledgment that validates that a receiving process has consumed the data. Alternatively, the acknowledgment may be one that only indicates that the data has reached its destination.

Reliable datagram service associates a local end-to-end (EE) context with one and only one remote end-to-end context. The reliable datagram service permits a client process of one queue pair to communicate with any other queue pair on any other remote node. At a receive work queue, the reliable datagram service permits incoming messages from any send work queue on any other remote node.

The reliable datagram service greatly improves scalability because the reliable datagram service is connectionless. Therefore, an endnode with a fixed number of queue pairs can communicate with far more processes and endnodes with a reliable datagram service than with a reliable connection transport service. For example, if each of N host processor nodes contain P processes, and all P processes on each node wish to communicate with all the processes on all the other nodes, the reliable connection service requires P²×(N−1) queue pairs on each node. By comparison, the connectionless reliable datagram service only requires P queue pairs+(N−1) EE contexts on each node for exactly the same communications.

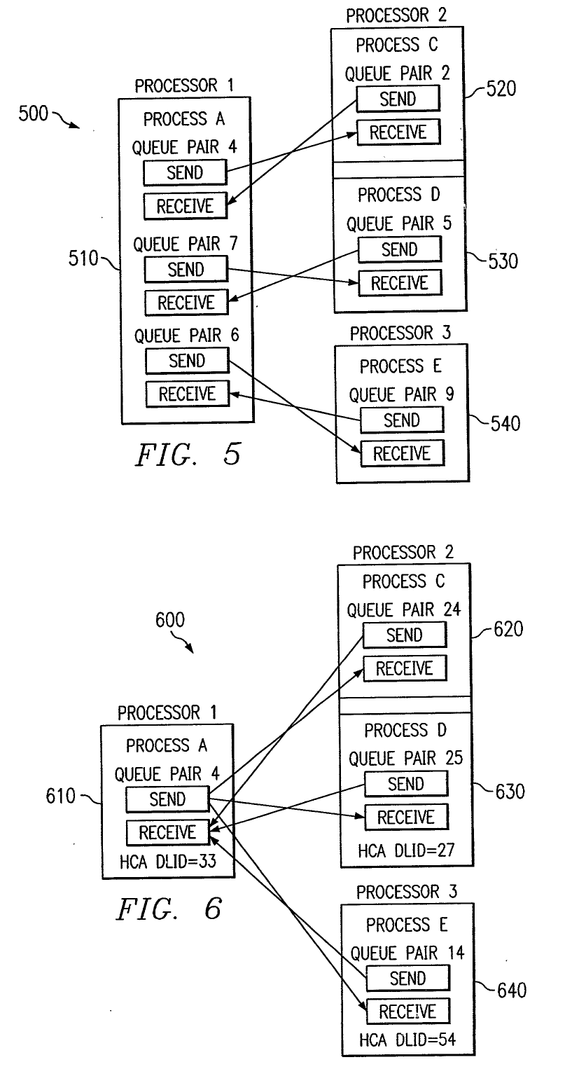

A portion of a distributed computer system employing a reliable datagram service to communicate between distributed processes is illustrated in FIG. 6. The distributed computer system 600 in FIG. 6 includes a host processor node 1, a host processor node 2, and a host processor node 3. Host processor node 1 includes a process A 610 having a queue pair 4. Host processor node 2 has a process C 620 having a queue pair 24 and a process D 630 having a queue pair 25. Host processor node 3 has a process E 640 having a queue pair 14.

In the reliable datagram service implemented in the distributed computer system 600, the queue pairs are coupled in what is referred to as a connectionless transport service. For example, a reliable datagram service couples queue pair 4 to queue pairs 24, 25 and 14. Specifically, a reliable datagram service allows queue pair 4's send work queue to reliably transfer messages to receive work queues in queue pairs 24, 25 and 14. Similarly, the send queues of queue pairs 24, 25, and 14 can reliably transfer messages to the receive work queue in queue pair 4.

In one embodiment of the present invention, the reliable datagram service employs sequence numbers and acknowledgments associated with each message frame to ensure the same degree of reliability as the reliable connection service. End-to-end (EE) contexts maintain end-to-end specific state to keep track of sequence numbers, acknowledgments, and time-out values. The end-to-end state held in the EE contexts is shared by all the connectionless queue pairs communication between a pair of endnodes. Each endnode requires at least one EE context for every endnode it wishes to communicate with in the reliable datagram service (e.g., a given endnode requires at least N EE contexts to be able to have reliable datagram service with N other endnodes).

The unreliable datagram service is connectionless. The unreliable datagram service is employed by management applications to discover and integrate new switches, routers, and endnodes into a given distributed computer system. The unreliable datagram service does not provide the reliability guarantees of the reliable connection service and the reliable datagram service. The unreliable datagram service accordingly operates with less state information maintained at each endnode.

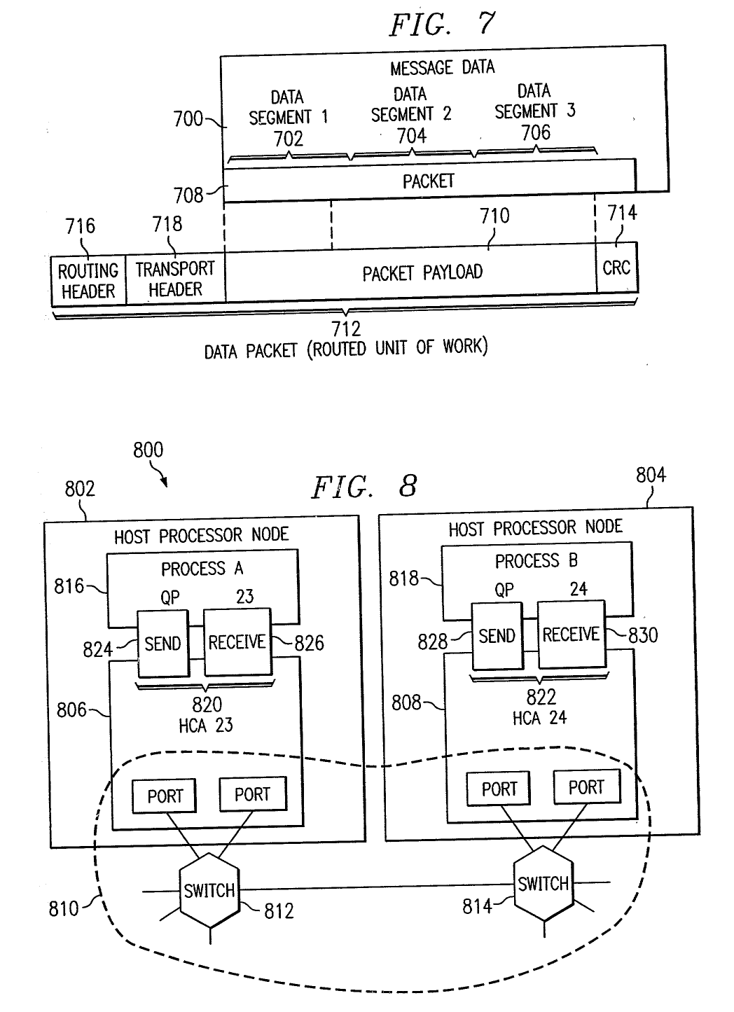

Turning next to FIG. 7, an illustration of a data packet is depicted in accordance with a preferred embodiment of the present invention. A data packet is a unit of information that is routed through the SAN fabric. The data packet is an endnode-to-endnode construct, and is thus created and consumed by endnodes. For packets destined to a channel adapter (either host or target), the data packets are neither generated nor consumed by the switches and routers in the SAN fabric. Instead for data packets that are destined to a channel adapter, switches and routers simply move request packets or acknowledgment packets closer to the ultimate destination, modifying the variant link header fields in the process. Routers, also modify the packet's network header when the packet crosses a subnet boundary. In traversing a subnet, a single packet stays on a single service level.

Message data 700 contains data segment 1 702, data segment 2 704, and data segment 3 706, which are similar to the data segments illustrated in FIG. 4. In this example, these data segments form a packet 708, which is placed into packet payload 710 within data packet 712. Additionally, data packet 712 contains CRC 714, which is used for error checking. Additionally, routing header 716 and transport header 718 are present in data packet 712. Routing header 716 is used to identify source and destination ports for data packet 712. Transport header 718 in this example specifies the destination queue pair for data packet 712. Additionally, transport header 718 also provides information such as the operation code, packet sequence number, and partition for data packet 712.

The operating code identifies whether the packet is the first, last, intermediate, or only packet of a message. The operation code also specifies whether the operation is a send, RDMA write, RDMA read, or atomic. The packet sequence number is initialized when communication is established and increments each time a queue pair creates a new packet. Ports of an endnode may be configured to be members of one or more possibly overlapping sets called partitions.

In FIG. 8, a portion of a distributed computer system is depicted to illustrate an example request and acknowledgment transaction. The distributed computer system in FIG. 8 includes a host processor node 802 and a host processor node 804. Host processor node 802 includes a host channel adapter 806. Host processor node 804 includes a host channel adapter 808. The distributed computer system in FIG. 8 includes a SAN fabric 810, which includes a switch 812 and a switch 814. The SAN fabric includes a link coupling host channel adapter 806 to switch 812; a link coupling switch 812 to switch 814; and a link coupling host channel adapter 808 to switch 814.

In the example transactions, host processor node 802 includes a client process A. Host processor node 804 includes a client process B. Client process A interacts with host channel adapter hardware 806 through queue pair 23. Client process B interacts with hardware channel adapter hardware 808 through queue pair 24. Queue pairs 23 and 24 are data structures that include a send work queue and a receive work queue.

Process A initiates a message request by posting work queue elements to the send queue of queue pair 23. Such a work queue element is illustrated in FIG. 4. The message request of client process A is referenced by a gather list contained in the send work queue element. Each data segment in the gather list points to part of a virtually contiguous local memory region, which contains a part of the message, such as indicated by data segments 1, 2, and 3, which respectively hold message parts 1, 2, and 3, in FIG. 4.

Hardware in host channel adapter 806 reads the work queue element and segments the message stored in virtual contiguous buffers into data packets, such as the data packet illustrated in FIG. 7. Data packets are routed through the SAN fabric, and for reliable transfer services, are acknowledged by the final destination endnode. If not successfully acknowledged, the data packet is retransmitted by the source endnode. Data packets are generated by source endnodes and consumed by destination endnodes.

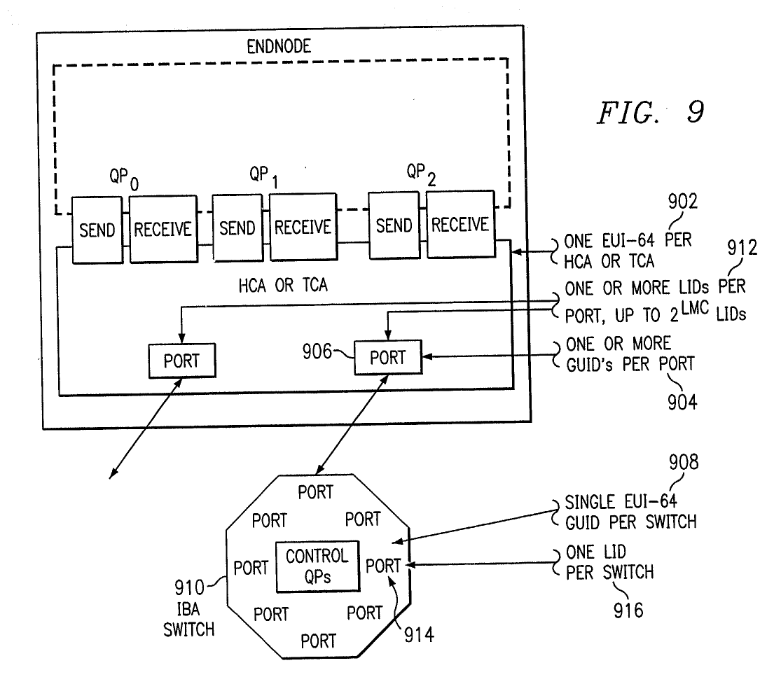

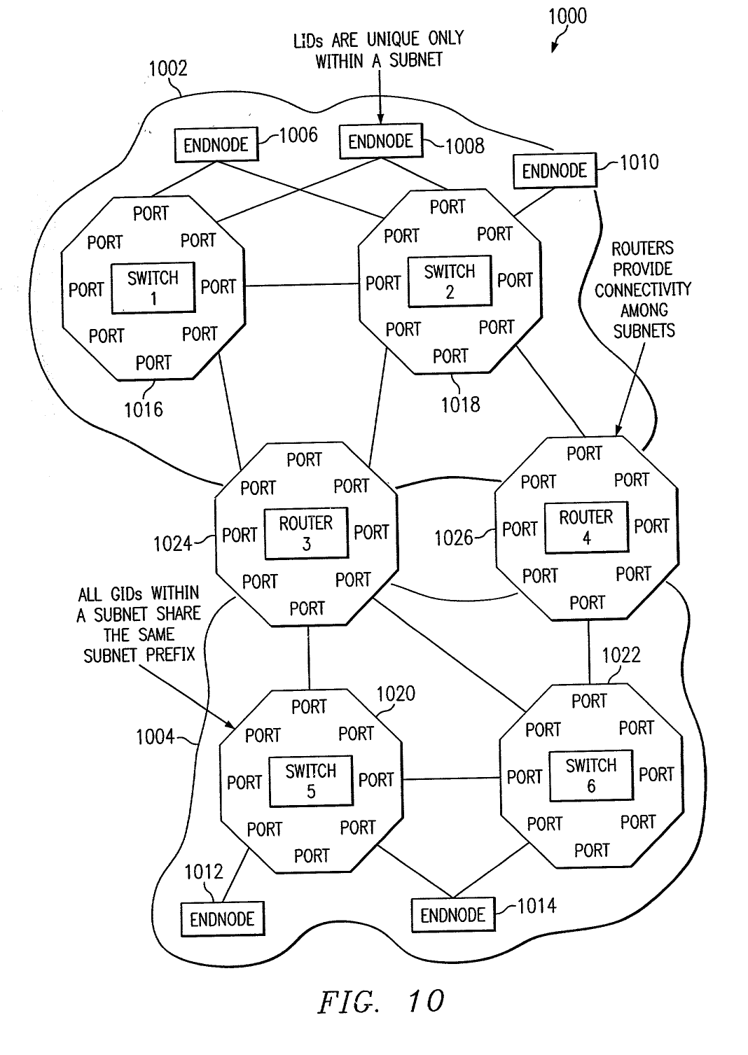

In reference to FIG. 9, a diagram illustrating the network addressing used in a distributed networking system is depicted in accordance with the present invention. A host name provides a logical identification for a host node, such as a host processor node or I/O adapter node. The host name identifies the endpoint for messages such that messages are destined for processes residing on an end node specified by the host name. Thus, there is one host name per node, but a node can have multiple CAs.

A single IEEE assigned 64-bit identifier (EUI-64) 902 is assigned to each component. A component can be a switch, router, or CA.

One or more globally unique ID (GUID) identifiers 904 are assigned per CA port 906. Multiple GUIDs (a.k.a. IP addresses) can be used for several reasons, some of which are illustrated by the following examples. In one embodiment, different IP addresses identify different partitions or services on an end node. In a different embodiment, different IP addresses are used to specify different Quality of Service (QoS) attributes. In yet another embodiment, different IP addresses identify different paths through intra-subnet routes.

One GUID 908 is assigned to a switch 910.

A local ID (LID) refers to a short address ID used to identify a CA port within a single subnet. In one example embodiment, a subnet has up to 2¹⁶ end nodes, switches, and routers, and the LID is accordingly 16 bits. A source LID (SLID) and a destination LID (DLID) are the source and destination LIDs used in a local network header. A single CA port 906 has up to 2^{LMC} LIDs 912 assigned to it. The LMC represents the LID Mask Control field in the CA. A mask is a pattern of bits used to accept or reject bit patterns in another set of data.

Multiple LIDs can be used for several reasons some of which are provided by the following examples. In one embodiment, different LIDs identify different partitions or services in an end node. In another embodiment, different LIDs are used to specify different QoS attributes. In yet a further embodiment, different LIDs specify different paths through the subnet.

A single switch port 914 has one LID 916 associated with it.

A one-to-one correspondence does not necessarily exist between LIDs and GUIDs, because a CA can have more or less LIDs than GUIDs for each port. For CAs with redundant ports and redundant connectivity to multiple SAN fabrics, the CAs can, but are not required to, use the same LID and GUID on each of its ports.

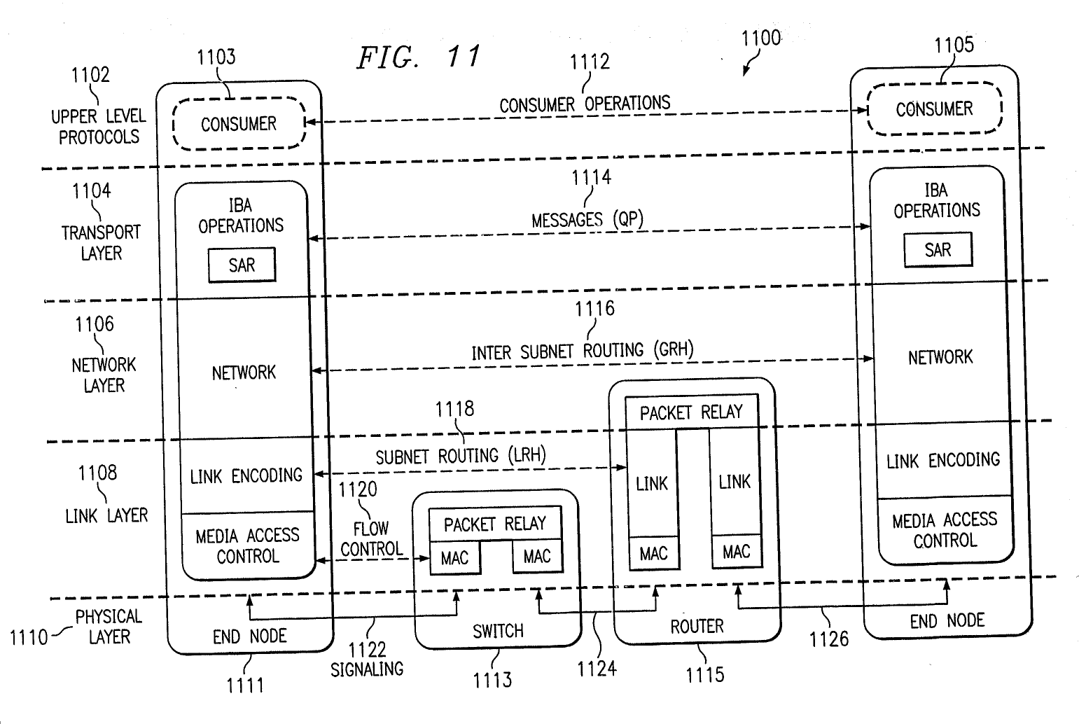

A portion of a distributed computer system in accordance with a preferred embodiment of the present invention is illustrated in FIG. 10. Distributed computer system 1000 includes a subnet 1002 and a subnet 1004. Subnet 1002 includes host processor nodes 1006, 1008, and 1010. Subnet 1004 includes host processor nodes 1012 and 1014. Subnet 1002 includes switches 1016 and 1018. Subnet 1004 includes switches 1020 and 1022.

Routers connect subnets. For example, subnet 1002 is connected to subnet 1004 with routers 1024 and 1026. In one example embodiment, a subnet has up to 216 endnodes, switches, and routers.

A subnet is defined as a group of endnodes and cascaded switches that is managed as a single unit. Typically, a subnet occupies a single geographic or functional area. For example, a single computer system in one room could be defined as a subnet. In one embodiment, the switches in a subnet can perform very fast wormhole or cut-through routing for messages.

A switch within a subnet examines the DLID that is unique within the subnet to permit the switch to quickly and efficiently route incoming message packets. In one embodiment, the switch is a relatively simple circuit, and is typically implemented as a single integrated circuit. A subnet can have hundreds to thousands of endnodes formed by cascaded switches.

As illustrated in FIG. 10, for expansion to much larger systems, subnets are connected with routers, such as routers 1024 and 1026. The router interprets the IP destination ID (e.g., IPv6 destination ID) and routes the IP-like packet.

An example embodiment of a switch is illustrated generally in FIG. 3B. Each I/O path on a switch or router has a port. Generally, a switch can route packets from one port to any other port on the same switch.

Within a subnet, such as subnet 1002 or subnet 1004, a path from a source port to a destination port is determined by the LID of the destination host channel adapter port. Between subnets, a path is determined by the IP address (e.g., IPv6 address) of the destination host channel adapter port and by the LID address of the router port which will be used to reach the destination's subnet.

In one embodiment, the paths used by the request packet and the request packet's corresponding positive acknowledgment (ACK) or negative acknowledgment (NAK) frame are not required to be symmetric. In one embodiment employing oblivious routing, switches select an output port based on the DLID. In one embodiment, a switch uses one set of routing decision criteria for all its input ports. In one example embodiment, the routing decision criteria are contained in one routing table. In an alternative embodiment, a switch employs a separate set of criteria for each input port.

A data transaction in the distributed computer system of the present invention is typically composed of several hardware and software steps. A client process data transport service can be a user-mode or a kernel-mode process. The client process accesses host channel adapter hardware through one or more queue pairs, such as the queue pairs illustrated in FIGS. 3A, 5, and 6. The client process calls an operating-system specific programming interface, which is herein referred to as “verbs.” The software code implementing verbs posts a work queue element to the given queue pair work queue.

There are many possible methods of posting a work queue element and there are many possible work queue element formats, which allow for various cost/performance design points, but which do not affect interoperability. A user process, however, must communicate to verbs in a well-defined manner, and the format and protocols of data transmitted across the SAN fabric must be sufficiently specified to allow devices to interoperate in a heterogeneous vendor environment.

In one embodiment, channel adapter hardware detects work queue element postings and accesses the work queue element. In this embodiment, the channel adapter hardware translates and validates the work queue element's virtual addresses and accesses the data.

An outgoing message is split into one or more data packets. In one embodiment, the channel adapter hardware adds a transport header and a network header to each packet. The transport header includes sequence numbers and other transport information. The network header includes routing information, such as the destination IP address and other network routing information. The link header contains the Destination Local Identifier (DLID) or other local routing information. The appropriate link header is always added to the packet. The appropriate global network header is added to a given packet if the destination endnode resides on a remote subnet.

If a reliable transport service is employed, when a request data packet reaches its destination endnode, acknowledgment data packets are used by the destination endnode to let the request data packet sender know the request data packet was validated and accepted at the destination. Acknowledgment data packets acknowledge one or more valid and accepted request data packets. The requester can have multiple outstanding request data packets before it receives any acknowledgments. In one embodiment, the number of multiple outstanding messages, i.e. Request data packets, is determined when a queue pair is created.

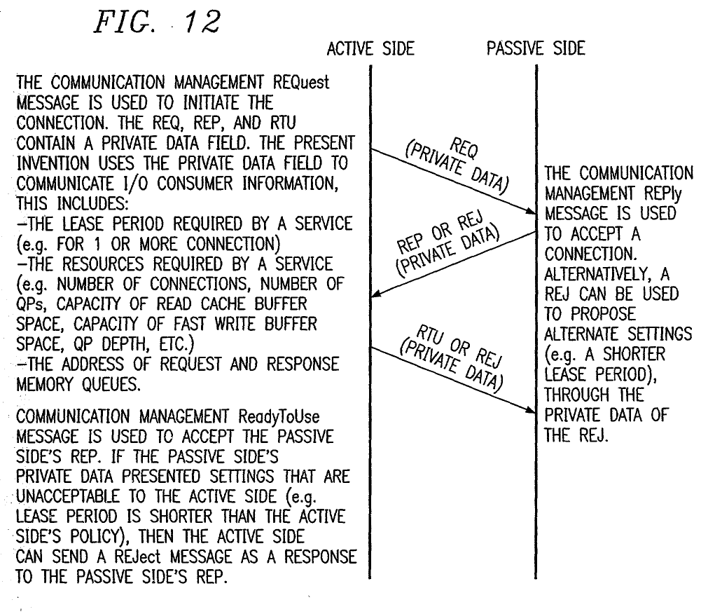

One embodiment of a layered architecture 1100 for implementing the present invention is generally illustrated in diagram form in FIG. 11. The layered architecture diagram of FIG. 11 shows the various layers of data communication paths, and organization of data and control information passed between layers.

Host channel adapter endnode protocol layers (employed by endnode 1111, for instance) include an upper level protocol 1102 defined by consumer 1103, a transport layer 1104; a network layer 1106, a link layer 1108, and a physical layer 1110. Switch layers (employed by switch 1113, for instance) include link layer 1108 and physical layer 1110. Router layers (employed by router 1115, for instance) include network layer 1106, link layer 1108, and physical layer 1110.

Layered architecture 1100 generally follows an outline of a classical communication stack. With respect to the protocol layers of end node 1111, for example, upper layer protocol 1102 employs verbs to create messages at transport layer 1104. Transport layer 1104 passes messages (1114) to network layer 1106. Network layer 1106 routes packets between network subnets (1116). Link layer 1108 routes packets within a network subnet (1118). Physical layer 1110 sends bits or groups of bits to the physical layers of other devices. Each of the layers is unaware of how the upper or lower layers perform their functionality.

Consumers 1103 and 1105 represent applications or processes that employ the other layers for communicating between endnodes. Transport layer 1104 provides end-to-end message movement. In one embodiment, the transport layer provides four types of transport services, as described, above which are reliable connection service; reliable datagram service; unreliable datagram service; and unreliable connection service. Network layer 1106 performs packet routing through a subnet or multiple subnets to destination endnodes. Link layer 1108 performs flow-controlled, error checked, and prioritized packet delivery across links.

Physical layer 1110 performs technology-dependent bit transmission. Bits or groups of bits are passed between physical layers via links 1122, 1124, and 1126. Links can be implemented with printed circuit copper traces, copper cable, optical cable, or with other suitable links.

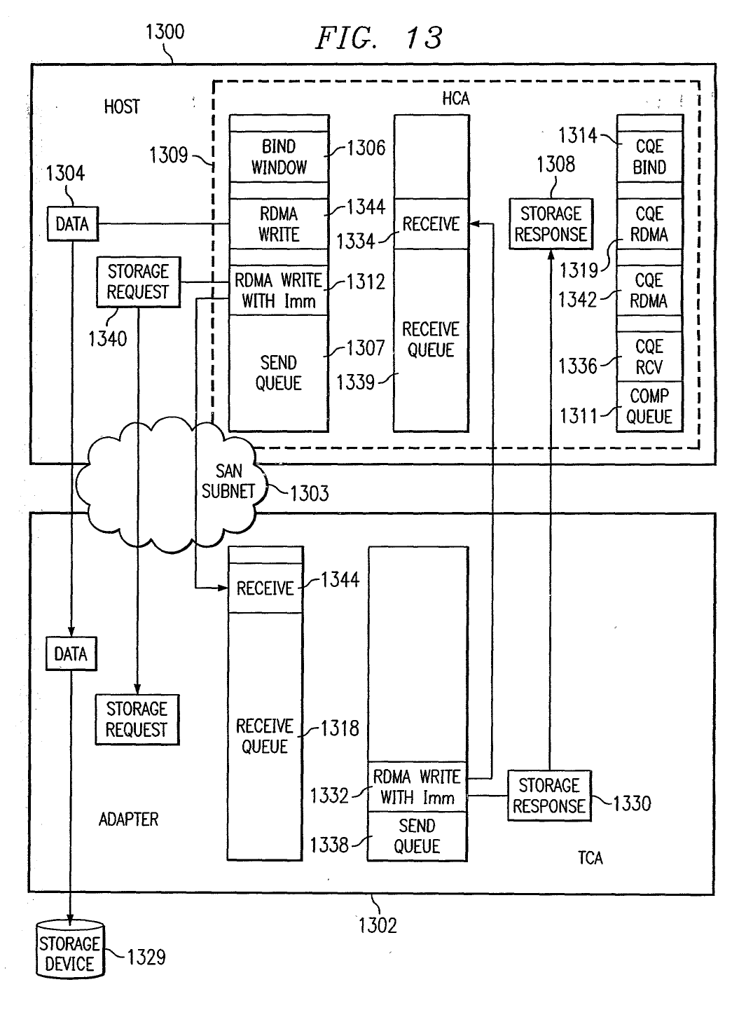

FIG. 12 is a diagram showing the flow of Communication Management packets to establish a connection and exchange private data in a preferred embodiment of the present invention.

The following terms will be used in the descriptions that follow: “Storage Data” is used to designate the data which will be written/read to/from storage and read/written from/to host memory. “Storage Request” is used to designate the storage command block passed by the device driver to the storage adapter. “Storage Response” is used to designate the storage return block passed by the storage adapter to the device driver.

FIG. 12 illustrates how during the connection establishment process, the adapter uses a connection management protocol REP reply message's private data field to pass back to the device driver the memory attributes of the adapter's Storage Request and Storage (Write) Data areas. The memory attributes consist of the initial memory address(es), length(s), and R_key(s) of each area. The Storage Request area is used to contain Storage Request Control Blocks from the host. The Storage Data area is used to contain the Storage Data which will be transferred from the host to the adapter (and ultimately to the storage device).

During normal operations the device driver pushes, via a Post Write RDMA with Immediate Data, a Storage Request message into the adapter's Storage Request memory region. If the Storage Request is a Write to disk, the device driver must first push the Storage Data into the adapter using a Write RDMA. The adapter interprets the request message and if it is a write to storage, the adapter either places the Storage Data in the media or commits it to nonvolatile store at the adapter. If the Request message is a read from storage, the adapter reads the Storage Data from media or its adapter buffer (whichever holds the most recent version of the Storage Data) and then uses a Write RDMA to write the Storage Data into host memory at the location specified in the Request message.

When the data transfers complete, the adapter sends a storage Response message back to the host. The Response message includes a transaction ID, which is used by the host device driver to associate the Response message to the original Request message. The host device driver retrieves the Storage Response message as a (receive) work completion.

Detailed Steps for I/O Write and I/O Read

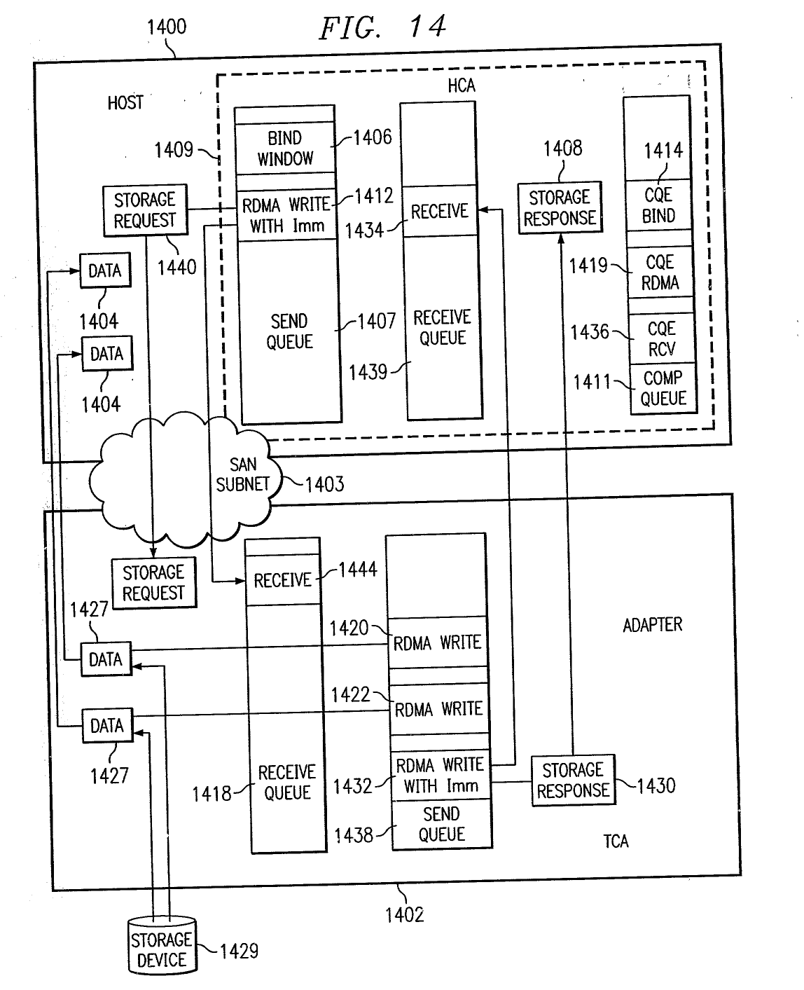

One embodiment of an upper layer protocol used for I/O in a preferred embodiment of the present invention is generally illustrated in diagram form in FIG. 13 and FIG. 14. FIG. 13 describes a method for processing a memory semantic I/O write to storage operation. FIG. 14 describes a method for processing a memory semantic I/O read to storage operation.

Detailed Steps for I/O Write

Referring now to FIG. 13, an upper-layer I/O write semantic protocol between a host 1300 and storage device adapter 1302, connected by SAN subnet 1303, operates as follows:

A process running on host 1300 first stores data 1304, which is to be written, in memory. The process then invokes a device driver associated with the storage device adapter, specifying that data 1304 is to be transferred to adapter 1302 for storage.

Then memory space for a response message 1308 is allocated within host 1300.

A “bind memory window” work request element 1306 is placed on send queue 1307, so that when “bind memory window” work request element 1306 is processed, host channel adapter 1309 will be given permission to access storage response 1308.

An RDMA write work queue element 1341 for the data transfer is generated and placed on send queue 1307.

The device driver creates a storage request 1340 in the memory of host 1300. Storage request 1340 includes a transaction ID (used to correlate response message, once created, with storage request 1340), a command type (I/O write in this case), a list of data segments (including starting virtual address, R_Key, and length), a disk address (e.g., SCSI address, SCSI logical unit number), and a linear block address (i.e., the location where the data will be placed on storage device 1329).

Then a write RDMA with immediate work queue element 1312 is generated, set to point to storage request 1340, and placed on send queue 1307. If, at this point, “bind memory window” work request element 1306 has been processed, a “bind” completion queue element 1314 is placed on completion queue 1311.

When host channel adapter 1309 processes write RDMA work queue element 1341, it transfers data 1304, via RDMA transfer, to adapter 1302. RDMA completion queue element 1319 is generated and placed on completion queue 1311. Next, when host channel adapter 1309 processes write RDMA with immediate work queue element 1312, it sends storage request 1340 to adapter 1302 via an RDMA transfer to adapter 1302. The “immediate data” is a pointer or index into storage request 1340, as stored in adapter 1302 after being transferred. This immediate data is placed in receive work queue element 1344 on receive queue 1318. After sending storage request 1340 to adapter 1302, host channel adapter 1309 will generate a “RDMA” completion queue element 1342 and place it on completion queue 1311. Adapter 1302 processes receive work queue element 1344 and uses storage request 1340 and writes data 1304 to storage device 1329 according to the instructions within storage request 1340.

At the close of the write transaction, adapter 1302 generates a response 1330 and an associated write RDMA with immediate work queue element 1332, which is placed on send queue 1338. When write RDMA with immediate element 1332 is interpreted and processed, response 1330 is transmitted via RDMA transfer by adapter 1302 to host 1300, where it is stored in location 1308, which was reserved for the response message. A “receive” work queue element 1334 is then generated on receive queue 1339 and the “immediate data” (in this case, completion status information regarding the transfer) from the response RDMA transfer is placed within “receive” work queue element 1334 so that the message can be processed. Finally, “receive” work queue element 1334 is processed, and a “receive” completion queue element 1336 is generated and placed on completion queue 1311.

Detailed Steps for I/O Read

Referring now to FIG. 14, an upper-layer I/O read protocol between a host 1400 and storage device adapter 1402, connected by SAN subnet 1403, operates as follows:

A process running on host 1400 first reserves a memory space for holding read data 1404. The process then invokes a device driver associated with the storage device adapter, specifying that data from storage device 1429 is to be read into read data memory space 1404.

Then memory space for a response message 1408 is allocated within host 1400.

The device driver creates a storage request 1440 in the memory of host 1400. Storage request 1440 includes a transaction ID (used to correlate response message, once created, with storage request 1440), a command type (I/O read in this case), a list of data segments (including starting virtual address, R_Key, and length), a disk address (e.g., SCSI address, SCSI logical unit number), and a linear block address (i.e., the location where the data resides on storage device 1429).

A “bind memory window” verb 1406 is placed on send queue 1407, so that when “bind memory window” verb 1406 is processed, host channel adapter 1409 will be given permission to access storage response 1408.

Then a write RDMA with immediate data work queue element 1412 is generated, set to point to storage request 1440, and placed on send queue 1407. If, at this point, “bind memory window” verb 1406 has been processed, a “bind” completion queue element 1414 is placed on completion queue 1411.

When host channel adapter 1409 processes write RDMA with immediate work queue element 1412, it sends storage request 1440 to adapter 1402 via an RDMA transfer with immediate data. The “immediate data” is a pointer or index into storage request 1440, as stored in adapter 1402 after transfer. This immediate data is placed in receive work queue element 1444 on receive queue 1418. After sending storage request 1440 to adapter 1402, host channel adapter 1409 will generate a “RDMA” completion queue element 1419 and place it on completion queue 1411.

Adapter 1402 processes receive work queue element 1444, interprets storage request 1440, reads data 1427 from storage device 1429, and generates RDMA write work queue elements 1420 and 1422. Work queue elements 1420 and 1422, when interpreted, direct adapter 1402 to perform an RDMA transfer of data 1427 into read data memory space 1404.

At the close of the read transaction, adapter 1402 generates a response 1430 and an associated write RDMA with immediate work queue element 1432, which is placed on send queue 1438. When write RDMA with immediate element 1432 is interpreted and processed, response 1430 is transmitted via RDMA transfer by adapter 1402 to host 1400, where it is stored in location 1408, which was reserved for the response message. A “receive” work queue element 1434 is then generated on receive queue 1439 and the “immediate data” (in this case, completion status information regarding the transfer) from the response RDMA transfer is placed within “receive” work queue element 1434 so that the message can be processed. Finally, “receive” work queue element 1434 is processed, and a “receive” completion queue element 1436 is generated and placed on completion queue 1411.

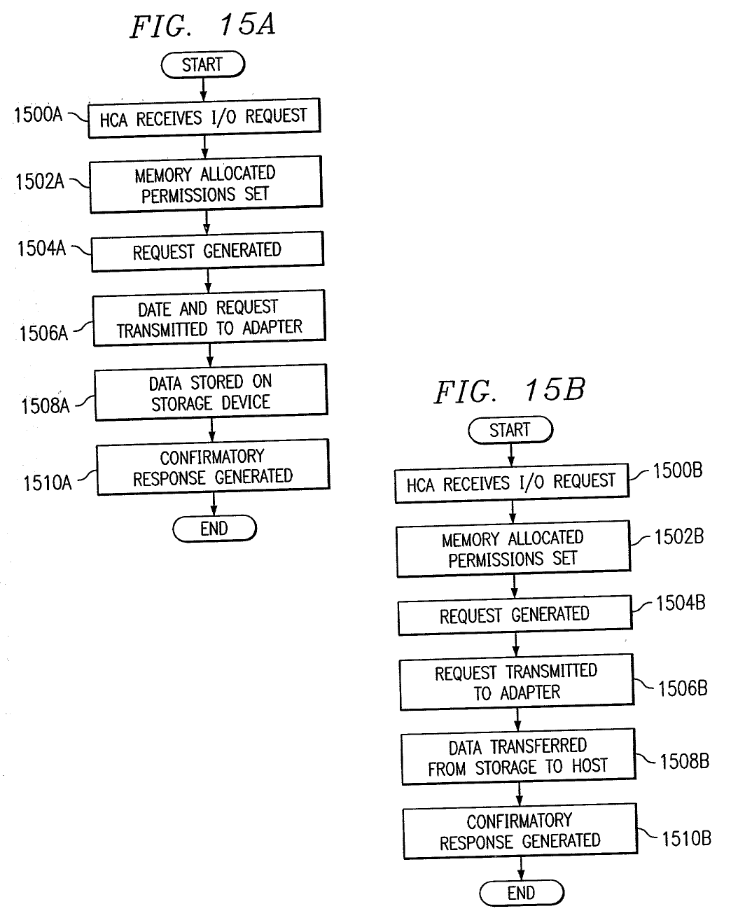

FIG. 15A is a flowchart representation of an upper-level memory semantic I/O write protocol in accordance with a preferred embodiment of the present invention. First the host channel adapter receives an input/output request from a process executing on the host (step 1500A). The host allocates memory for the transfer (e.g., a response message from the adapter) and sets the proper permissions to allow a remote direct memory access (RDMA) transfer to take place between the host and adapter (step 1502A). Next, the host generates a request describing the upcoming transfer (step 1504A). The storage request contains the virtual address, R_Key, and length of the storage data.

The host transmits the data and then the storage request to the adapter (step 1506A). The adapter then stores the data to a storage device (step 1508A). Finally, the adapter sends a confirmatory response message to the host to notify the host that a successful transaction has occurred (step 1510A).

FIG. 15B is a flowchart representation of an upper-level memory semantic I/O read protocol in accordance with a preferred embodiment of the present invention. First the host channel adapter receives an input/output request from a process executing on the host (step 1500B). The host allocates memory for the transfer (e.g., to hold data to be read and/or a response message from the adapter) and sets the proper permissions to allow a remote direct memory access (RDMA) transfer to take place between the host and adapter (step 1502B). Next, the host generates a request describing the upcoming transfer (step 1504B). The storage request contains the virtual address, R_Key, and length of the storage data.

The host transmits the storage request to the adapter (step 1506B). Based on the storage request, the host adapter initiates an RDMA transfer between the host and adapter to write data from the adapter's storage to the host adapter's memory (step 1508B). Finally, the adapter sends a confirmatory response message to the host to notify the host that a successful transaction has occurred (step 1510B).

It is important to realize that a number of optimizations may be employed to enhance the operation of the present invention as described in embodiment herein described. One such optimization is to reduce the number of confirmatory response messages sent from the adapter to the host by, for instance, limiting the number of responses to one per a given number of transfers. Another is to forgo placing some or all of the completion queue elements on a completion queue.

To further improve performance, the input/output protocol herein described may be supplemented with a resource allocation scheme so as to reduce the workload of any one adapter or storage device. Examples of resource allocation techniques that may be applied to the present invention include, but are not limited to, first-come-first-served resource access by a limited number of hosts to a given adapter, first-come-first-served resource access by a limited number of hosts for a limited time, predefined allocation of adapters to hosts, and the like. While not optimizations to the protocol, per se, these resource allocation schemes can make a significant contribution to the overall performance of an input/output system in accordance with the present invention.

The following is a list of optimizations to the basic methodology described herein:

1) The adapter can support a larger number of outstanding Storage I/O Write Requests than its internal Storage Data memory region by using a combination of the following two mechanisms for Storage Write Data.

a) Mechanism 1: Would be used when the device driver can place the Storage Write Data at an unused location in the adapter's Storage Data memory region. This mechanism follows the methodology described above in the Detailed Steps for I/O Write.

b) Mechanism 2: Would be used when the device driver cannot find a memory region to place the Storage Write Data. Under this mechanism, the device driver would include in the Storage Request the memory address, length, and R_Key associated with the Storage Data. The adapter would then use a Read RDMA to pull the Storage Data from the location specified in the Storage Request. This mechanism can also be used if the adapter has no Storage Data memory region at all.

2) The adapter can periodically change the R_Keys of the adapter's Storage (Write) Data and Storage Request memory regions/windows. That is, the R_Keys which provide access control to the adapter's memory regions and are used to contain Storage Requests and Storage (Write) Data. The methodology for changing the R_Keys is to include in the Storage Response a R_Key, Memory Address, and Length for each memory region referenced by the I/O transaction.

3) To remove the need to handle Bind and Send completions, the device driver can use unsignaled completions for most Bind and Send operations. Then periodically use a signaled Bind or Send to assure all previous (unsignaled) work requests completed successfully.

4) To remove the need to handle Bind, Send, and some Receive completions, the device driver can request Completion Queue Notification only in the case of a solicited event. The adapter can then use solicited events when transferring every N Storage Response messages. Where N represents the (variable, tunable) number of non-solicited event Storage Response messages to transfer before transferring a solicited event Storage Response message.

5) The adapter can aggregate several Storage Response messages into a single response using a single Write RDMA with Immediate Data. This further reduces network traffic and further reduces the number of interrupts taken by the host channel adapter. The responses can be aggregated either in the Immediate Data or contained within the Storage Response information.

6) For I/O Read, the adapter can use a Write RDMA with Immediate Data to transfer the Storage Data and the Storage Response block.

7) To reduce fragmentation of the Storage Request memory region, the device driver can use one of the following mechanisms:

a) Mechanism 1: Using one of several well known memory allocation and defragmentation algorithms. This mechanism follows the methodology described above in the Detailed Steps for I/O Write and I/O Read.

b) Mechanism 2: Using a single, constant Storage Request Control Block size (some requests would not use all of the available space).

c) Mechanism 3: Allowing Storage Request Control Blocks to be of variable size, but segmenting them into one or more constant sized chunks which are linked together.

8) To reduce the fragmentation of the Storage Data memory region, the device driver can use one of the following mechanisms:

a) Mechanism 1: Variable-sized Storage Data blocks for each request using one of several well known memory allocation and defragmentation algorithms. This mechanism follows the methodology described above in the Detailed Steps for I/O Write and I/O Read.

b) Mechanism 2: Fixed-size Storage Data blocks for each request using a single, constant Storage Block size (some/most write requests would not use all of the available space).

c) Mechanism 3: Variable-sized Storage Data blocks for each request using multiple, small, fixed-sized chunks within the Storage Data memory region described by a descriptor list specifying which blocks of the Storage Data memory region are used for this request. The descriptor list may be communicated to the adapter via a variety of methods, examples of which include:

i) The descriptor list may be contained within the Storage Request.

ii) The descriptor list may be contained as a single contiguous list using memory in the Storage Request memory region. The Storage Request contains the location of the descriptor list.

iii) The descriptor list may be contained within multiple fixed-size chunks in the Storage Request memory region with each chunk containing a contiguous list and a link to the next chunk. The Storage Request contains the location of the first chunk.

iv) The descriptor list may be distributed as part of each block of Storage Data, i.e. a linked list structure in which each block contains both write data and a link to the next block. The Storage Request contains the address of the first block of Storage Data.

v) The descriptor list may be contained as a single contiguous list using an additional block in the Storage Data memory region for reach Storage Write request. The Storage Request contains the location of the descriptor list.

vi) The descriptor list may be contained within multiple blocks in the Storage Data memory region for each Storage Write request, with each block containing a contiguous list and a link to the next block. The Storage Request contains the location of the descriptor list.

9) A further optimization may be made by transmitting the storage data and storage request using a single RDMA transfer with immediate data. This improves the performance of the protocol, as well as reducing memory usage by reducing the number of queue elements to be allocated.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, although the illustrations show communications from one node to another node, the mechanisms of the present invention may be implemented between different processes on the same node. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, operable in a data processing system having a host, for performing an input/output transaction, comprising:
sending, through a first remote direct memory access transfer, a request to an adapter; and
performing a second remote direct memory access transfer through a system area network, responsive to sending the request.

2. The method of claim 1, wherein the second remote direct memory access transfer includes the host writing data to the adapter.

3. The method of claim 1, wherein the second remote direct memory access transfer includes the adapter writing data to the host.

4. The method of claim 1, wherein the request includes remote direct memory access transfer parameters.

5. The method of claim 4, wherein the remote direct memory access transfer parameters include at least one of a transaction ID, a list of data segments, an identification of a storage device, and an address on a storage device.

6. The method of claim 1, further comprising:
receiving a confirmatory response from the adapter.

7. A method, operable in a data processing system having an adapter, for performing an input/output transaction, comprising:
receiving a request via a first remote direct memory access transfer from a host; and
performing a second remote direct memory access transfer with the host through a system area network, responsive to receiving the request.

8. The method of claim 7, wherein the second remote direct memory access transfer includes receiving data from memory of the host.

9. The method of claim 8, further comprising:
writing the data to a storage device.

10. The method of claim 7, wherein the remote direct memory access transfer includes sending data to be written to memory of the host.

11. The method of claim 10, further comprising:
reading the data from a storage device.

12. The method of claim 7, wherein the request includes remote direct memory access transfer parameters.

13. The method of claim 12, wherein the remote direct memory access transfer parameters include at least one of a transaction ID, a list of data segments, an identification of a storage device, and an address on a storage device.

14. The method of claim 7, further comprising:
sending a confirmatory response to the host.

15. A computer program product in a computer readable medium, for performing an input/output transaction in a computer system having a host, comprising instructions for:
sending, through a first remote direct memory access transfer, a request to an adapter; and
performing a second remote direct memory access transfer through a system area network, responsive to sending the request.

16. The computer program product of claim 15, wherein the second remote direct memory access transfer includes the host writing data to the adapter.

17. The computer program product of claim 15, wherein the second remote direct memory access transfer includes the adapter writing data to the host.

18. The computer program product of claim 15, wherein the request includes remote direct memory access transfer parameters.

19. The computer program product of claim 18, wherein the remote direct memory access transfer parameters include at least one of a transaction ID, a list of data segments, an identification of a storage device, and an address on a storage device.

20. The computer program product of claim 15, comprising addition instructions for:
receiving a confirmatory response from the adapter.

21. A computer program product, operable in a data processing system having an adapter, for performing an input/output transaction, comprising:
receiving a request via a first remote direct memory access transfer from a host; and
performing a second remote direct memory access transfer with the host through a system area network, responsive to receiving the request.

22. The computer program product of claim 21, wherein the second remote direct memory access transfer includes receiving data from memory of the host.

23. The computer program product of claim 22, comprising additional instructions for:
writing the data to a storage device.

24. The computer program product of claim 21, wherein the remote direct memory access transfer includes sending data to be written to memory of the host.

25. The computer program product of claim 24, further comprising:
reading the data from a storage device.

26. The computer program product of claim 21, wherein the request includes remote direct memory access transfer parameters.

27. The computer program product of claim 26, wherein the remote direct memory access transfer parameters include at least one of a transaction ID, a list of data segments, an identification of a storage device, and an address on a storage device.

28. The computer program product of claim 21, comprising additional instructions for:
sending a confirmatory response to the host.

29. A host, for performing an input/output transaction, comprising:
a bus system;
a processing unit connected to the bus system, wherein the processing unit includes at least one processor;
a primary memory; and
a set of instructions within the primary memory, wherein the processing unit executes the set of instructions to perform the acts of:
sending, through a first remote direct memory access transfer, a request to an adapter; and
performing a second remote direct memory access transfer through a system area network, responsive to sending the request.

30. The host of claim 29, wherein the second remote direct memory access transfer includes the host writing data to the adapter.

31. The host of claim 29, wherein the second remote direct memory access transfer includes the adapter writing data to the host.

32. The host of claim 29, wherein the request includes remote direct memory access transfer parameters.

33. The host of claim 32, wherein the remote direct memory access transfer parameters include at least one of a transaction ID, a list of data segments, an identification of a storage device, and an address on a storage device.

34. The host of claim 29, wherein the processing unit executes the set of instructions to perform the additional acts of:
receiving a confirmatory response from the adapter.

35. An adapter for performing an input/output transaction, comprising:
a bus system;
a processing unit connected to the bus system, wherein the processing unit includes at least one processor;
a primary memory; and
a set of instructions within the primary memory, wherein the processing unit executes the set of instructions to perform the acts of:
receiving a request via a first remote direct memory access transfer from a host; and
performing a second remote direct memory access transfer with the host through a system area network, responsive to receiving the request.

36. The adapter of claim 35, wherein the second remote direct memory access transfer includes receiving data from memory of the host.

37. The adapter of claim 36, wherein the processing unit executes the set of instructions to perform the additional acts of:
writing the data to a storage device.

38. The adapter of claim 35, wherein the remote direct memory access transfer includes sending data to be written to memory of the host.

39. The adapter of claim 38, wherein the processing unit executes the set of instructions to perform the additional acts of:
reading the data from a storage device.

40. The adapter of claim 35, wherein the request includes remote direct memory access transfer parameters.

41. The adapter of claim 40, wherein the remote direct memory access transfer parameters include at least one of a transaction ID, a list of data segments, an identification of a storage device, and an address on a storage device.

42. The adapter of claim 35, wherein the processing unit executes the set of instructions to perform the additional acts of:
sending a confirmatory response to the host.
